(19) United States
(12) Patent Application Publication
(10) Pub. No.: US 2018/0180070 A1
(43) Pub. Date: Jun. 28, 2018

(54) VALVE BODY FOR HYDRAULIC CONTROL DEVICE, AND PRODUCTION METHOD THEREFOR

(71) Applicant: MAZDA MOTOR CORPORATION, Hiroshima (JP)

(72) Inventors: Tatsuya UESUGI, Onomichi-shi, Hiroshima (JP); Kazuhiko UEDA, Hatsukaichi-shi, Hiroshima (JP); Shinya KAMADA, Kure-shi, Hiroshima (JP); Shotaro NAGAI, Hiroshima-shi, Hiroshima (JP); Koshiro SAJI, Tokai-shi, Aichi (JP)

(73) Assignee: MAZDA MOTOR CORPORATION, Hiroshima (JP)

(21) Appl. No.: 15/739,205

(22) PCT Filed: Jun. 21, 2016
(86) PCT No.: PCT/JP2016/002992

§ 371 Date: Dec. 22, 2017

(30) Foreign Application Priority Data
Jun. 23, 2015 (JP) 2015-125947

(51) Int. Cl. F15B 13/08; B33Y 80/00; B29C 64/153

(52) U.S. Cl. CPC F15B 13/0814; B33Y 80/00; B33Y 10/00; F15B 13/0835; F15B 13/0871; B29C 64/153

(57) ABSTRACT

Disclosed herein is a valve body (10) for a hydraulic control system. The valve body (10) has a plurality of valve insertion holes (33, 34) into which a plurality of valves are inserted, respectively, and a plurality of oil passages (69) each communicating with at least one of the valve insertion holes (33, 34). The valve body (10) includes: an insertion hole arrangement member (11) provided with the valve insertion holes (33, 34) of the valve body (10), which are arranged in a concentrated manner; and an oil passage arrangement member (12) placed on the insertion hole arrangement member (11), and provided with the oil passages (69) of the valve body (10), which are arranged in a concentrated manner.

### TECHNICAL FIELD

The present invention relates to a valve body for a hydraulic control system (device) for use to control the hydraulic pressure of, for example, an automatic transmission of a vehicle, and a method for producing the valve body.

### BACKGROUND ART

In general, an automatic transmission installed in a vehicle includes a hydraulic control system, which controls the supply and discharge of engagement hydraulic oil into and from a hydraulic pressure chamber of each of a plurality of frictional engagement elements forming a transmission mechanism, the supply of lubricating oil to target portions of the interior of a transmission case, and the supply of oil to a torque converter, for example.

As disclosed in Patent Document 1, a known valve body for a hydraulic control system includes a plurality of valve body components, which are layered. These valve body components and separate plates are unitized by being fastened together using a plurality of bolts with one of the separate plates interposed between facing surfaces of each adjacent pair of the valve body components. Each of the layered valve body components is formed using a die by die casting of aluminum or any other process. This allows such valve body components to be precisely and efficiently produced in large quantity.

The valve body includes a solenoid valve, a spool valve, and any other valve assembled thereto. At least one of the layered valve body components has a plurality of valve insertion holes into each of which a small-diameter portion of the solenoid valve extending from a solenoid portion of the solenoid valve, a spool of the spool valve, or any other component is inserted. These valve insertion holes are formed by machining (in particular, cutting) the at least one of the die-casted valve body components. These valve insertion holes extend in a direction parallel to the facing surfaces.

Each of the layered valve body components has a plurality of oil passages each communicating with at least one of the valve insertion holes. These oil passages, which extend along the facing surfaces of each adjacent pair of the valve body components, are formed through the formation of the valve body components with a die. Thus, removal of the die and the draft of the die need to be taken into account when the oil passages are to be designed.

Specifically, as shown in FIG. 16, in order to enable removal of a die 901 which is designed to be removed in the direction indicated by the arrow, all oil passages 801 of a valve body component 800 each have an opening extending across the entire length of the oil passage 801 and formed through a facing surface 811 of the valve body component 800. This allows the cross section of each oil passage 801 to be in the shape of a groove having a predetermined depth from the facing surface 811 in a direction orthogonal to the facing surface (in the thickness direction of the valve body component 800). The cross section of the oil passage 801 is tapered with the draft of the die taken into account.

The oil passage openings of each layered valve body, which are formed through the associated facing surface, are closed with a separate plate. Opposite ones of the oil passages of two of the valve body components adjacent to each other with the separate plate interposed therebetween communicate with each other through an associated one of communication holes of the separate plate.

### CITATION LIST

### Patent Documents

PATENT DOCUMENT 1: Japanese Unexamined Patent Publication No. 2013-253653

### SUMMARY

### Technical Problem

However, if an attempt is made to allow the deepest portion of each oil passage 801, which has a cross section tapered as shown in FIG. 16, of the previously described known valve body to have a predetermined width, the width L1 of the opening of the oil passage 801 through the facing surface 811 increases. As a result, the entire facing surface 811 has to have an increased area, resulting in upsizing of the valve body. Conversely, to allow the width L1 of the opening of the oil passage 801 to be equal to a predetermined width, the width of a portion of the oil passage 801 deeper than the opening needs to be reduced. Thus, a valve body component having such oil passages 801 with a reduced width is heavier than a valve body component having oil passages 801 with a constant width throughout their depth. This leads to an increase in the weight of the entire valve body.

In the known valve body, all the oil passages 801 open through the facing surface 811. This prevents three or more of the oil passages 801 of each valve body component 800 from being arranged in the thickness direction of the valve body component. Specifically, as shown in FIG. 16, if only one surface of the valve body component 800 is a facing surface 811, only one of the oil passages 801 can be arranged in the thickness direction of the valve body component 800. As shown in FIG. 17, if both surfaces of a valve body component 800 are facing surfaces 811 and 812, only two of oil passages 801, 802 can be arranged in the thickness direction of the valve body component 800. Thus, it is impossible to adopt the layout of oil passages in which three or more oil passages are arranged in the thickness direction of each valve body component 800 having at most two facing surfaces 811.

To solve the problem described above, intensive development has been conducted. However, the precondition that a die is used to form every valve body component to achieve efficient mass production imposes various limitations described above on such development. Thus, under present circumstances, no revolutionary result has been obtained.

It is therefore an object of the present invention to provide a totally novel hydraulic control system valve body that may have a smaller size, a lower weight, and a higher degree of flexibility in designing oil passages, and a method for producing the valve body.

### Solution to the Problem

In order to achieve the object, one aspect of the present invention is directed to a valve body for a hydraulic control system. The valve body has a plurality of valve insertion holes into which a plurality of valves are inserted, respectively, and a plurality of oil passages each communicating with at least one of the valve insertion holes. The valve body includes: an insertion hole arrangement member provided with the valve insertion holes of the valve body, which are arranged in a concentrated manner; and an oil passage arrangement member placed on the insertion hole arrangement member, and provided with the oil passages of the valve body, which are arranged in a concentrated manner.

According to the foregoing configuration, the valve body for the hydraulic control system includes the insertion hole arrangement member and the oil passage arrangement member, the insertion hole arrangement member is provided with the valve insertion holes of the valve body, which are arranged in a concentrated manner, and the oil passage arrangement member is provided with the oil passages of the valve body, which are arranged in a concentrated manner. Thus, the oil passage arrangement member can be formed by a different production method from a production method for the insertion hole arrangement member. For example, the insertion hole arrangement member can be formed with a die, while the oil passage arrangement member can be formed by a three-dimensional layer manufacturing process without various constraints described above. To form an oil passage arrangement member by, in particular, a three-dimensional layer manufacturing process, removal of a die does not have to be taken into account. This can provide a high degree of flexibility in designing the shapes and layout of the oil passages, without constraints, such as the constraint that the oil passages must each have an opening extending across the length of the oil passage and formed through a surface of the oil passage arrangement member facing the insertion hole arrangement member. The high degree of flexibility in designing the oil passages allows the design of the oil passages to be easily changed. In addition, when the design is to be changed, there is no need for reshaping a die. Thus, the design of the oil passages can be changed in a short period of time at low cost.

Furthermore, if the oil passage arrangement member is formed by the three-dimensional layer manufacturing process, removal of a die and the draft of the die do not have to be taken into account. Thus, the cross-sectional shape of each oil passage of the oil passage arrangement member can be freely designed. Thus, the oil passages of the oil passage arrangement member do not have to each have an opening extending across the length of the oil passage and formed through the facing surface of the oil passage arrangement member. The communication ports of the oil passage arrangement member opening through the facing surface to communicate with, and be connected to, the valve insertion holes do not have to each have a cross section tapered down by increasing the sizes of the openings of the communication ports through the facing surface or by reducing the width of each of surfaces of the communication ports opposite from the facing surface. This can prevent increasing the sizes of the openings of the communication ports through the facing surface of the oil passage arrangement member from enlarging the entire facing surface, or can prevent reducing the width of each of surfaces of the communication ports opposite from the facing surface from increasing the weight of the oil passage arrangement member. This can reduce the size and weight of the valve body.

Furthermore, each oil passage of the oil passage arrangement member merely needs to open through a portion of the facing surface of the oil passage arrangement member required to allow the oil passage to communicate with, and be connected to, the associated valve insertion hole. Thus, in a situation where the valve body component includes the oil passages each having an opening extending across the length of the oil passage and formed through the facing surface, a separate plate for use to close most parts of the openings of the oil passages of the valve body component can be omitted, unlike a known valve body.

In one embodiment of the valve body for the hydraulic control system, the insertion hole arrangement member may be formed by die casting.

As can be seen from the foregoing description, the insertion hole arrangement member is formed by die casting that has been generally performed. Thus, a high-quality insertion hole arrangement member with sufficient rigidity can be obtained using a technology that has been nurtured for a long time. In particular, if, after the formation of the insertion hole arrangement member, the insertion hole arrangement member is machined (in particular, cut) to form valve insertion holes, machining the insertion hole arrangement member with high rigidity allows the valve insertion holes to be precisely formed. The insertion hole arrangement member with high rigidity is less likely to become deformed even after the machining of the valve insertion holes. Thus, in particular, a spool can be smoothly moved through a valve insertion hole for a spool valve.

In addition, in a known valve body, a member having oil passages may be machined (cut) to form valve insertion holes. In this case, cut dust produced by machining the valve insertion holes may enter the oil passages. If the cut dust enters the narrow oil passages, the cut dust is difficult to discharge. In contrast to this, the present invention eliminates the need for forming oil passages in the insertion hole arrangement member, or merely requires a small number of oil passages even if oil passages are formed. This can substantially prevent the cut dust produced by machining the valve insertion holes from entering the oil passages. The valve insertion holes are usually designed to each have a diameter that is larger than the width or diameter of each oil passage, and are usually formed to open through a side surface of the insertion hole arrangement member in order to allow the associated valves to be inserted thereinto after the insertion hole arrangement member and the oil passage arrangement member are placed one over the other. This allows cut dust in the valve insertion hole to be easily discharged through the opening formed through the side surface of the insertion hole arrangement member.

In another embodiment of the valve body for the hydraulic control system, the oil passage arrangement member may be made of a resin.

Specifically, the oil passage arrangement member that does not have to be machined to form valve insertion holes does not need to have as high rigidity as that of the insertion hole arrangement member. Thus, the oil passage arrangement member can be made of a resin. This can reduce the weight of the oil passage arrangement member.

If the oil passage arrangement member made of a resin is formed by the three-dimensional layer manufacturing process, more printing methods can be used than if an oil passage arrangement member made of a metal is formed by the three-dimensional layer manufacturing process. Thus, an oil passage arrangement member with desired quality is easily formed. In addition, if the oil passage arrangement member made of a metal is formed (manufactured) by the three-dimensional layer manufacturing process, support portions for supporting a product portion of the oil passage arrangement member being manufactured from below have to be manufactured so as to be connected to the product portion. After the manufacturing of the oil passage arrangement member, the support portions have to be removed, and the remaining portions have to be finished. In contrast, if the oil passage arrangement member made of a resin is formed by the three-dimensional layer manufacturing process, there is no need for forming the support portions, depending on the printing method used (for example, in a powder-sintered layer manufacturing process). As a result, there is no need for forming the support portions and finishing the remaining portions.

In still another embodiment of the valve body for the hydraulic control system, the insertion hole arrangement member may include a plurality of insertion hole arrangement members, and/or the oil passage arrangement member may include a plurality of oil passage arrangement members. The insertion hole arrangement members and the oil passage arrangement members may be alternately placed one over another.

This increases the degree of flexibility in designing how the valve insertion holes of the insertion hole arrangement member are allowed to communicate with the associated oil passages of the oil passage arrangement member.

In yet another embodiment of the valve body for the hydraulic control system, a plurality of first communication ports each communicating with at least one of the valve insertion holes may open through a surface of the insertion hole arrangement member facing the oil passage arrangement member, a plurality of second communication ports each connected to an associated one of the communication ports of the insertion hole arrangement member may open through a surface of the oil passage arrangement member facing the insertion hole arrangement member, and a sealing member may be provided around an opening of at least one of the first communication port or the second communication port to seal a junction between the first and second communication ports.

Thus, the junction between each pair, connected together, of the communication ports of the insertion hole arrangement member and the oil passage arrangement member is sealed with the sealing member. Thus, even if the entire facing surfaces of the insertion hole arrangement member and the oil passage arrangement member are not brought into tight contact with each other by being fastened together using many bolts, only four corners of the facing surfaces of the insertion hole arrangement member and the oil passage arrangement member, for example, may be fastened together with bolts to provide high sealability. This can reduce the number of bolts for use to fasten the insertion hole arrangement member and the oil passage arrangement member together, and thus reduce the space required to form bolt holes and their surrounding bosses, thereby further reducing the size and weight of the valve body.

In a known valve body, a sheet-like gasket may be interposed between facing surfaces of a plurality of valve body components to fill the entire gap between the facing surfaces. To address the problem, providing the sealing member can eliminate such a gasket. This can reduce the number of components.

In addition, to prevent oil leaking through the opening of an oil passage from flowing through the facing surfaces of the valve body components of the known valve body into a different oil passage adjacent to the oil passage, a drain oil passage may be provided between the adjacent oil passages such that the leaking oil is intentionally guided into the drain oil passage. In contrast, providing the sealing member can prevent oil from an oil passage from flowing through the gap between the facing surfaces of the insertion hole arrangement member and the oil passage arrangement member into a different oil passage without providing a drain oil passage in one of the facing surfaces of the insertion hole arrangement member and the oil passage arrangement member, unlike the known valve body. Thus, eliminating such a drain oil passage can further reduce the size of the oil passage arrangement member.

In a further embodiment of the valve body for the hydraulic control system, the sealing member may be provided around the opening of each of the second communication ports of the oil passage arrangement member, the oil passage arrangement member may include a body portion made of a synthetic resin and integrated with the sealing member, and the sealing member may be made of a synthetic resin that is softer than the body portion.

This provides high sealability while reducing the number of components and the number of assembly process steps.

In a still further embodiment of the valve body for the hydraulic control system, the insertion hole arrangement member and/or the oil passage arrangement member may have an orifice member insertion port into which an orifice member separate from the insertion hole arrangement member and the oil passage arrangement member is inserted.

In a yet further embodiment of the valve body for the hydraulic control system, the insertion hole arrangement member and/or the oil passage arrangement member may have a check valve insertion port into which a check valve separate from the insertion hole arrangement member and the oil passage arrangement member is inserted.

Another aspect of the present invention is directed to a method for producing a valve body for a hydraulic control system. The valve body has a plurality of valve insertion holes into which a plurality of valves are inserted, respectively, and a plurality of oil passages each communicating with at least one of the valve insertion holes. The method according to this aspect of the invention includes: forming, with a die, an insertion hole arrangement member, the insertion hole arrangement member being provided with valve insertion holes of the valve body, which are arranged in a concentrated manner; forming, by a three-dimensional layer manufacturing process, an oil passage arrangement member, the oil passage arrangement member being provided with oil passages of the valve body, which are arranged in a concentrated manner; and after the forming of the insertion hole arrangement member and after the forming of the oil passage arrangement member, fastening the insertion hole arrangement member and the oil passage arrangement member together with the insertion hole arrangement member and the oil passage arrangement member placed one over the other.

Thus, the valve body described above can be easily produced. The valve body includes the insertion hole arrangement member including the valve insertion holes of the valve body, which are arranged in a concentrated manner, and the oil passage arrangement member including the oil passages of the valve body, which are arranged in a concentrated manner.

### Advantages of the Invention

As can be seen from the foregoing description, according to a hydraulic control system valve body of the present invention and a method for producing the same, the size and weight of a valve body can be reduced, and the degree of flexibility in designing oil passages can be increased.

### BRIEF DESCRIPTION OF THE DRAWINGS

FIG. 1 is a side view of a valve body for a hydraulic control system according to a first embodiment of the present invention as viewed in the direction in which the axes of valve insertion holes extend.

FIG. 2 is a side view illustrating an insertion hole arrangement member and an oil passage arrangement member of the valve body shown in FIG. 1 which have been disassembled.

FIG. 3 is a plan view of the valve body shown in FIG. 1.

FIG. 4A illustrates a surface of an insertion hole arrangement member facing an oil passage arrangement member, and FIG. 4B illustrates a surface of the oil passage arrangement member facing the insertion hole arrangement member.

FIG. 5 is a cross-sectional view showing the internal structure of the valve body, and taken along the plane V-V shown in FIG. 3.

FIG. 6 is a cross-sectional view showing the internal structure of the valve body, and taken along the plane VI-VI shown in FIG. 1.

FIG. 7 is a cross-sectional view showing the internal structure of the valve body, and taken along the plane VII-VII shown in FIG. 1.

FIG. 8 illustrates oil passages according to a variation, and corresponds to FIG. 6.

FIG. 9 is a cross-sectional view showing an exemplary sealing member and its surrounding area.

FIG. 10 illustrates a first variation of a sealing member, and corresponds to FIG. 9.

FIG. 11 illustrates a second variation of a sealing member, and corresponds to FIG. 9.

FIG. 12 illustrates a third variation of a sealing member, and corresponds to FIG. 9.

FIG. 13 illustrates a valve body for a hydraulic control system according to a second embodiment of the present invention, and corresponds to FIG. 1.

FIG. 14 illustrates a valve body for a hydraulic control system according to a third embodiment of the present invention, and corresponds to FIG. 1.

FIG. 15 illustrates a valve body for a hydraulic control system according to a fourth embodiment of the present invention, and corresponds to FIG. 1.

FIG. 16 is a cross-sectional view schematically showing an exemplary valve body component and an exemplary die for a known valve body.

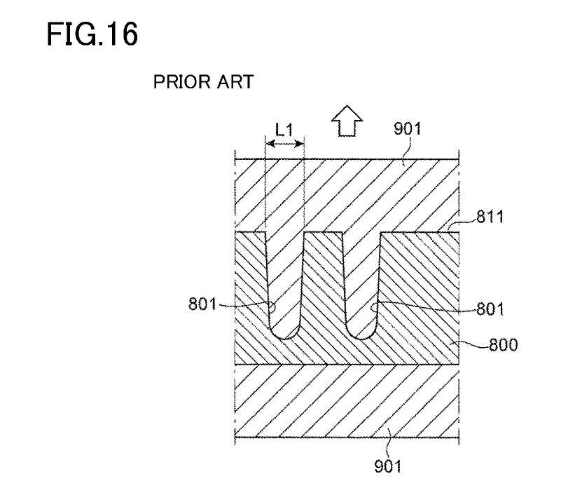

FIG. 17 is a cross-sectional view schematically showing another exemplary valve body component and another exemplary die for a known valve body.

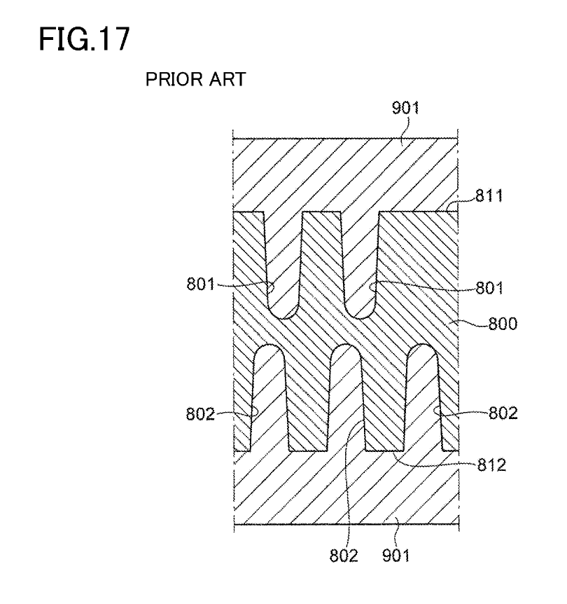

### DESCRIPTION OF EMBODIMENTS

Embodiments of the present invention will now be described in detail with reference to the drawings.

### First Embodiment

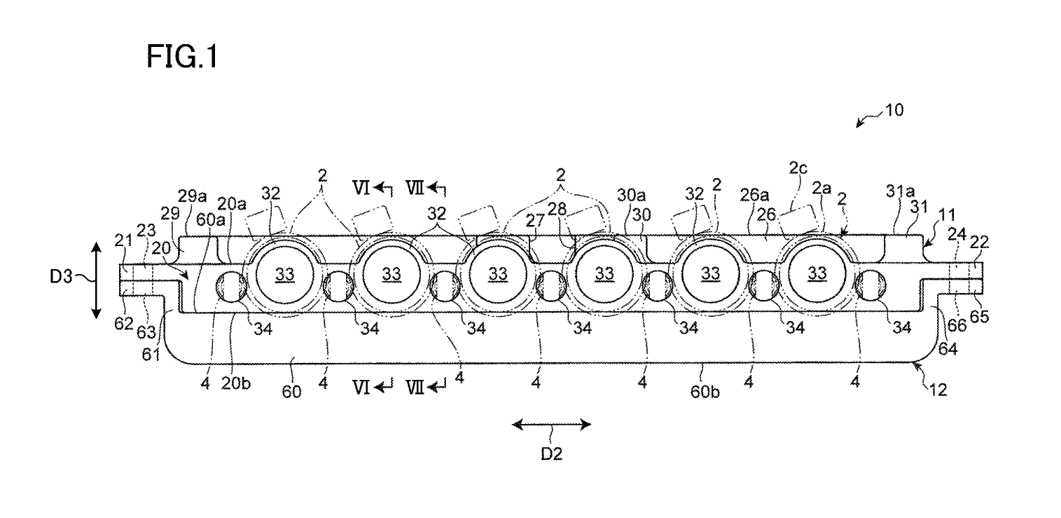

FIG. 1 illustrates a valve body 10 for a hydraulic control system according to a first embodiment of the present invention. The hydraulic control system is used to control the hydraulic pressures supplied to an automatic transmission and a torque converter that are installed in a vehicle. The valve body 10 for the hydraulic control system is assembled to a transmission case (not shown) of the automatic transmission. Specifically, the valve body 10 is attached to the lower surface of the transmission case. However, where the valve body 10 should be attached is merely an example. The valve body 10 may be attached to, for example, an upper surface or a side surface of the transmission case.

As shown in FIGS. 1-4B, in this embodiment, the valve body 10 is shaped to extend in a predetermined direction (in the direction D2 shown in FIGS. 1-4B), and is flat. Specifically, the valve body 10 has a short length in the direction D3 perpendicular to the direction D2. In this embodiment, it can be said that the direction D2 represents the longitudinal direction of the valve body 10, and the direction D3 represents the thickness direction of the valve body 10. In addition, it can be said that the direction D1 perpendicular to each of the directions D2 and D3 represents the width direction of the valve body 10. In a state where the valve body 10 is attached to the automatic transmission, the direction D3 corresponds to a vertical direction. The upper and lower sides of the valve body 10 in the following description of a configuration for the valve body 10 correspond to the upper and lower sides of the attached valve body.

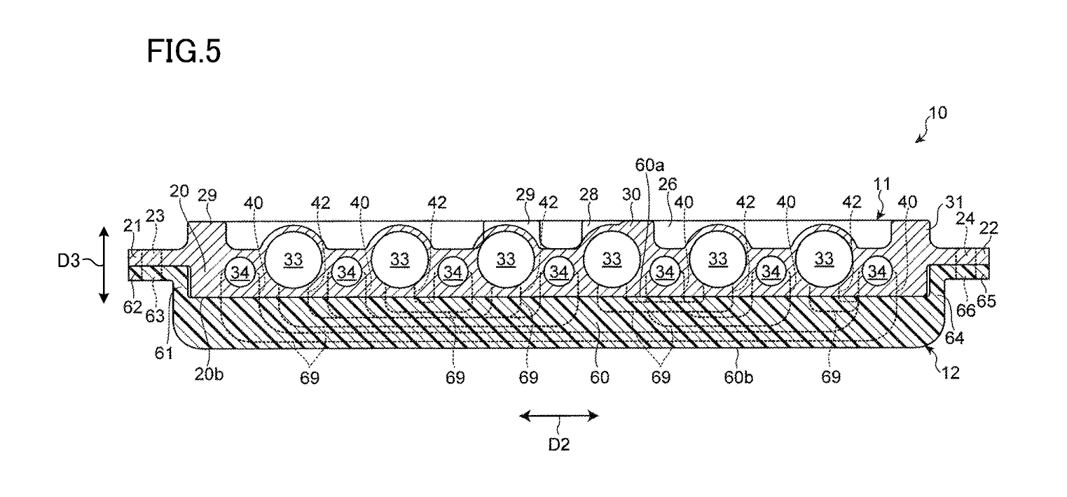

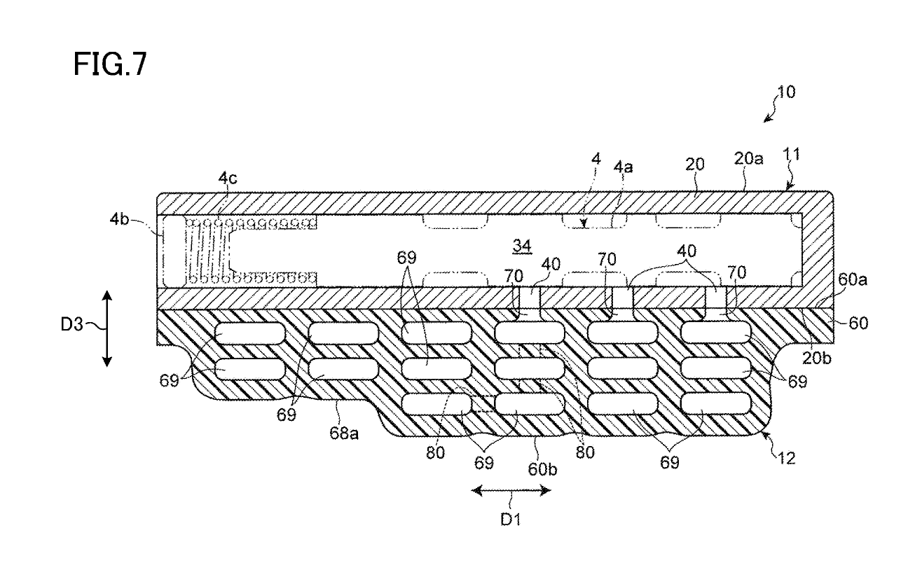

As shown in FIGS. 5-7, the valve body 10 has a plurality of valve insertion holes 33, 34 including at least one valve insertion hole 33 and at least one valve insertion hole 34, and a plurality of oil passages 69 each communicating with at least one 33 or 34 of the valve insertion holes 33, 34. In this embodiment, the at least one valve insertion hole 33 includes a plurality of valve insertion holes 33, and the at least one valve insertion hole 34 includes a plurality of valve insertion holes 34. As shown in FIGS. 1, 3, and 6, a small-diameter portion 2b of a solenoid valve 2, described below, is inserted into each valve insertion hole 33. As shown in FIGS. 1 and 7, a spool valve 4 is inserted into each valve insertion hole 34. These valves 2, 4 constitute a hydraulic control circuit (not shown) together with the oil passages 69. The number of types of valves inserted into the respective valve insertion holes of the valve body 10 should not be limited to two, but may be one, three, or more.

The hydraulic control circuit is connected to sources of hydraulic pressure (a mechanical oil pump and an electric oil pump), a hydraulic pressure chamber for each of a plurality of frictional engagement elements (a clutch and a brake) constituting a transmission mechanism, lubrication target portions of the interior of the transmission case, lubrication target portions of the torque converter, a hydraulic pressure chamber of a lockup clutch, and other elements through a plurality of oil passages provided in the wall of the transmission case. Controlling an operation of each of the valves 2 and 4 allows control of, for example, the supply and discharge of engagement hydraulic oil into and from the hydraulic pressure chamber of each frictional engagement element, the supply of lubricating oil to the lubrication target portions of the interior of the transmission case, and the supply of oil to the torque converter.

As shown in FIG. 7, each spool valve 4 includes a spool 4a inserted into, and housed in, an associated one of the valve insertion holes 34. The spool 4a is movable along the axis of the spool 4a (along the axis of the valve insertion hole 34). The spool valve 4 further includes a stopper 4b fixed at a predetermined location in the valve insertion hole 34 (near the opening of the valve insertion hole 34), and a return spring 4c interposed between the stopper 4b and the spool 4a so as to be extendable and retractable along the axis of the spool 4a.

The spool valve 4 has its spool 4a axially moved in accordance with the hydraulic pressure input to a control port (not shown) of the spool valve 4. Thus, the spool valve 4 adjusts the discharge pressure from its communication ports 40 described below, and selects one of hydraulic pressure supply paths. Specifically, the spool valve 4 functions as a switching valve having various functions, such as the functions of a pressure regulator valve adjusting the discharge pressure of the mechanical oil pump to a line pressure, a manual valve selecting one of the hydraulic pressure supply paths in conjunction with an operation of a shift lever by a vehicle's operator, and a fail-safe valve selecting one of the hydraulic pressure supply paths to achieve a predetermined gear in the event of a failure in the solenoid valve 2.

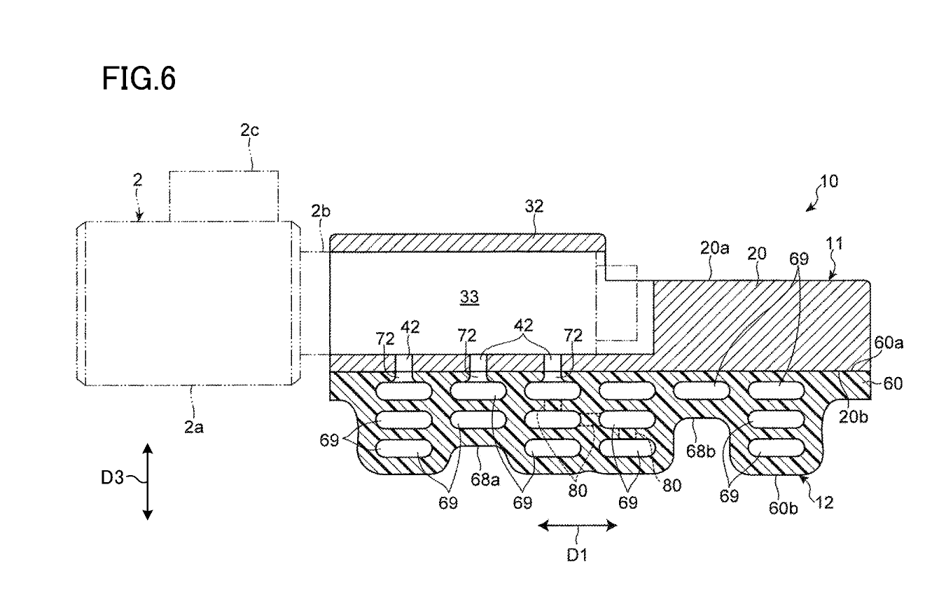

As shown in FIG. 6, the solenoid valve 2 includes a cylindrical solenoid portion 2a housing therein a coil, and a cylindrical small-diameter portion 2b having a smaller diameter than the solenoid portion 2a and extending coaxially from the solenoid portion 2a in the direction in which the axis of the solenoid portion 2a extends (in the direction in which the axis of the valve insertion hole 33 extends). The solenoid valve 2 is assembled to the valve body 10 (specifically, an insertion hole arrangement member 11 described below) with the small-diameter portion 2b inserted into the valve insertion hole 33. The outer peripheral surface of the solenoid portion 2a is provided with a connector 2c to be connected to a cable for passing current through the coil.

A linear solenoid valve or an on/off solenoid valve is used as the solenoid valve 2. The linear solenoid valve is used as a valve to directly control the hydraulic pressure supplied into the hydraulic pressure chamber of the associated frictional engagement element, for example. The on/off solenoid valve is used as a valve to open and close the hydraulic pressure supply path leading to the control port of the spool valve 4, for example.

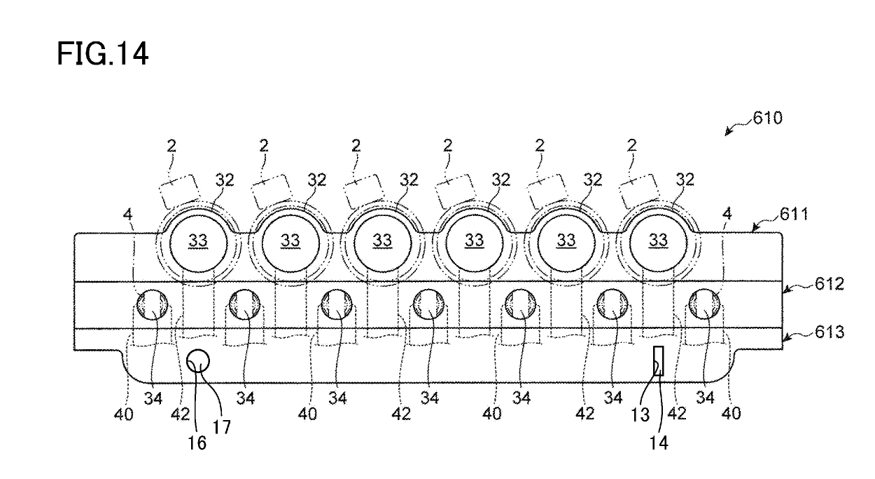

Note that the valve body 10 may further include other components, such as a check valve and an orifice member, forming part of the hydraulic control circuit and integrated with the valve body. The components, such as the check valve and the orifice member, may be each configured as a part separate from the valve body 10 (the insertion hole arrangement member 11 and an oil passage arrangement member 12, described below). In this case, the separate part may be inserted into, and fitted into, an insertion port of the valve body 10 (the insertion hole arrangement member 11 and/or the oil passage arrangement member 12). FIG. 14, which shows a third embodiment described below, shows an oil passage arrangement member 613 having an orifice member insertion port 13 into which an orifice member 14 is inserted, and a check valve insertion port 16 into which a check valve 17 is inserted.

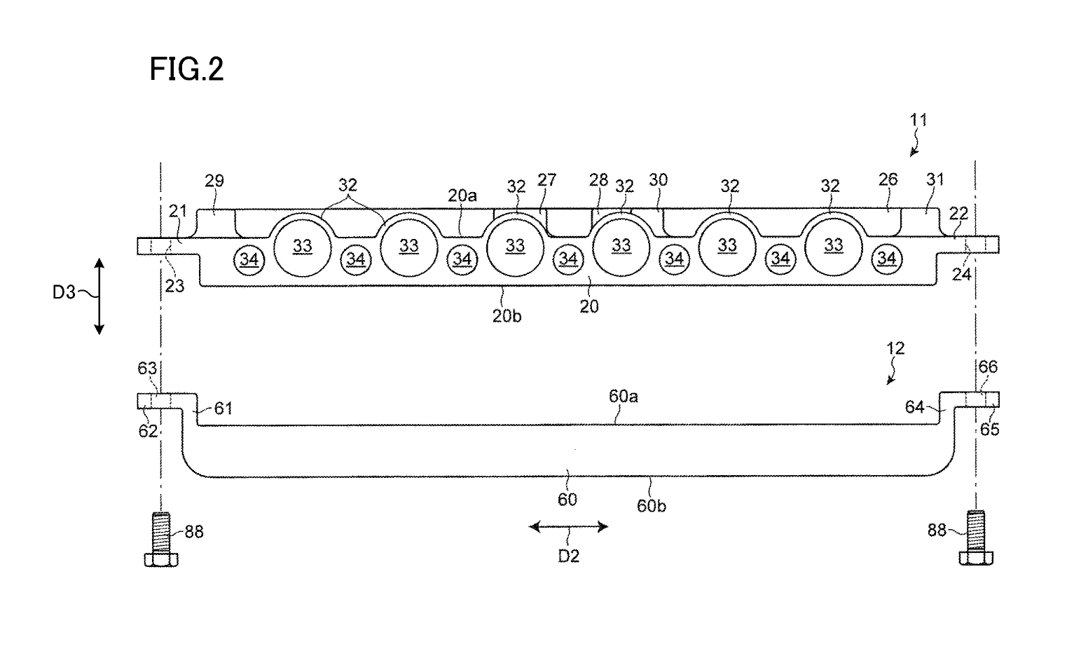

As shown in FIG. 2, the valve body 10 includes the insertion hole arrangement member 11, and the oil passage arrangement member 12. The insertion hole arrangement member 11 has the valve insertion holes 33, 34 (all of the valve insertion holes 33, 34 of the valve body 10) arranged (formed) in a concentrated manner. The oil passage arrangement member 12 has the oil passages (all of the oil passages 69 of the valve body 10) arranged (formed) in a concentrated manner. The insertion hole arrangement member 11 and the oil passage arrangement member 12 are fastened together while being placed one over the other in the direction D3. In this embodiment, the insertion hole arrangement member 11 is located above the oil passage arrangement member 12 in a situation where the valve body 10 is attached to the automatic transmission.

The insertion hole arrangement member 11 is a member formed with a die and made of metal. Specifically, the insertion hole arrangement member 11 is a member formed by die casting and made of aluminum. The insertion hole arrangement member 11 includes, for example, a body portion 20 having a flat block shape, and a pair of flange portions 21, 22 each protruding outward in the direction D2 from an upper portion of an associated one of both end surfaces of the body portion 20 in the direction D2. The body portion 20 has an upper surface 20a, and a lower surface 20b facing the oil passage arrangement member 12. The upper surface 20a (except swelling portions 32 and protruding portions 26-31 described below) is parallel to the lower surface 20b. The flange portions 21, 22 respectively have bolt holes 23, 24 into and through each of which a bolt 88 is inserted and runs to fix the insertion hole arrangement member 11 to the transmission case together with the oil passage arrangement member 12. The lower surface 20b of the body portion 20 is hereinafter referred to as the facing surface 20b.

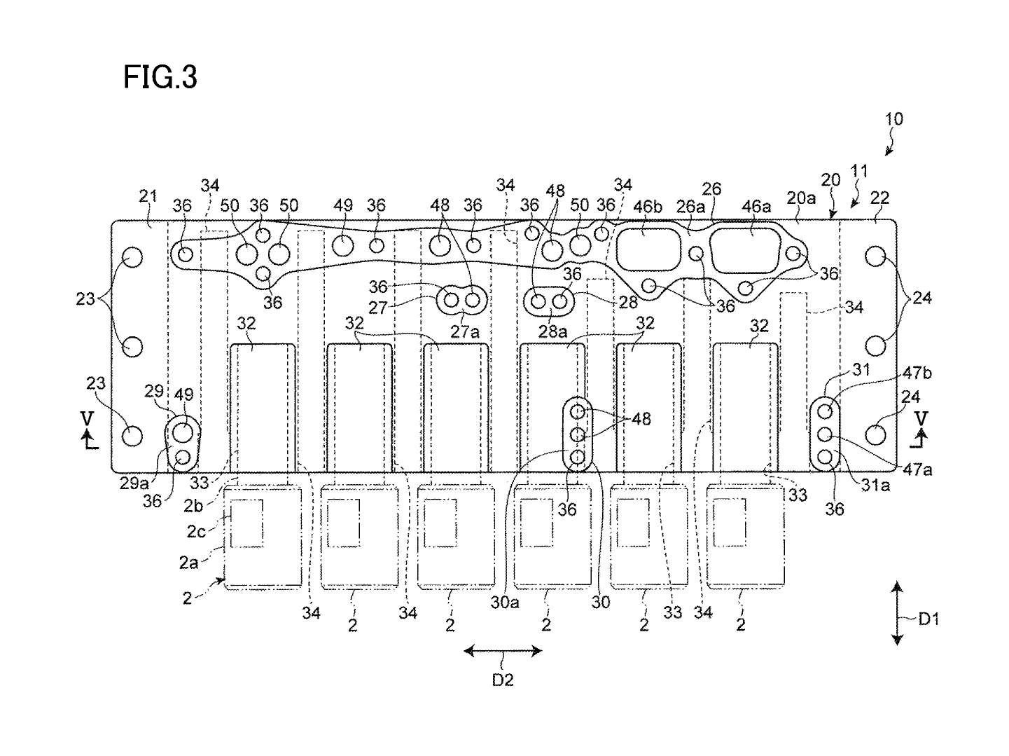

As shown in FIGS. 2 and 3, the upper surface 20a of the body portion 20 of the insertion hole arrangement member 11 has the protruding portions 26-31 protruding upward. The upper surfaces 26a-31a of these protruding portions 26-31 are located on the same plane, for example, and are brought into contact with the lower surface of the transmission case.

The insertion hole arrangement member 11 has a plurality of bolt holes 36 into and through each of which a bolt is inserted and runs to fix the valve body 10 to the transmission case. Each bolt hole 36 penetrates the insertion hole arrangement member 11 in the thickness direction (in the direction D3) thereof, and opens through the facing surface 20b and any one of the upper surfaces 26a-31a of the protruding portions 26-31.

A plurality of communication ports 46a, 46b, 47a, 47b, 48, 49, 50 each open through an associated one of the upper surfaces 26a-31a of the protruding portions 26-31. Each communication port 46a, 46b, 47a, 47b, 48, 49, 50 communicates with, and is connected to, an associated one of the oil passages of the transmission case. These communication ports 46a, 46b, 47a, 47b, 48, 49, 50 are each connected to a specific one of the oil passages 69. As a result, these specific oil passages 69 communicate with the respective oil passages of the transmission case through the respective communication ports 46a, 46b, 47a, 47b, 48, 49, 50. Each communication port 46a, 46b, 47a, 47b, 48, 49, 50 opens also through the facing surface 20b so as to be connected to the specific oil passage 69 of the oil passage arrangement member 12 at the facing surface 20b, or is connected to the specific oil passage 69 through a specific one of the valve insertion holes 33, 34 and either communication ports 42, 72 or communication ports 40, 70 which communicate with the specific valve insertion hole and which will be described below.

The communication ports 46a, 46b, 47a, 47b, 48, 49, 50 are connected through the oil passages of the transmission case to the sources of hydraulic pressure, the hydraulic pressure chamber for each of the frictional engagement elements, the lubrication target portions of the interior of the transmission case, the lubrication target portions of the torque converter, and the hydraulic pressure chamber of the lockup clutch. For example, the communication port 46a is connected to a suction port of the mechanical oil pump, while the communication port 46b is connected to a discharge port of the mechanical oil pump. The communication port 47a is connected to a suction port of the electric oil pump, while the communication port 47b is connected to a discharge port of the electric oil pump. The communication ports 48 are connected to the hydraulic pressure chambers of the frictional engagement elements, respectively, while the communication ports 49 are connected to the lubrication target portions of the interior of the transmission case, respectively. The communication ports 50 are connected to the lubrication target portions of the torque converter and the hydraulic pressure chamber of the lockup clutch, respectively.

The valve insertion holes 33, 34 are formed by machining (cutting) the insertion hole arrangement member 11 formed by die casting. The valve insertion holes 33, 34 extend in a direction parallel to the facing surface 20b. The valve insertion holes 33, 34 (all of the valve insertion holes 33, 34 of the valve body 10) are formed in the insertion hole arrangement member 11 such that the axes of the valve insertion holes 33, 34 extend in the direction D1, and are parallel to one another. All of the valve insertion holes 33, 34 open on the same side in the direction D1 (through one side surface of the insertion hole arrangement member 11 in the direction D1). This allows all of the valve insertion holes 33, 34 to be formed by machining from the same direction. In this embodiment, it can also be said that the direction D1 corresponds to the direction in which the axes of the valve insertion holes 33, 34 extend. Note that all of the valve insertion holes 33, 34 do not have to open on the same side in the direction D1. The axes of all of the valve insertion holes 33, 34 do not have to extend in the direction D1.

The valve insertion holes 33 for solenoid valves 2 each have a larger diameter than the valve insertion holes 34 for spool valves 4. The valve insertion holes 34 are arranged to fit between the upper surface 20a and facing surface 20b of the body portion 20. On the other hand, the valve insertion holes 33 are arranged to protrude upward beyond the upper surface 20a of the body portion 20. A portion of the peripheral wall of each valve insertion hole 33 corresponding to the protruding portion thereof is configured as the swelling portion 32 swelling upward from the upper surface 20a of the body portion 20.

In this embodiment, the valve insertion holes 33 for the solenoid valves 2 and the valve insertion holes 34 for the spool valves 4 are alternately arranged in the direction D2. If the valve insertion holes 34 each having a relatively small diameter are each interposed between an associated adjacent pair of the valve insertion holes 33 each having a relatively large diameter, these valve insertion holes 33, 34 can be densely arranged in the direction D2. This can reduce the dimension of the insertion hole arrangement member 11 in the direction D2. Note that the valve insertion holes 33, 34 do not always have to be alternately arranged as described above.

As shown in FIGS. 5-7, the insertion hole arrangement member 11 has the communication ports 42, 40. The communication ports 42 extend downward from the respective valve insertion holes 33 for the solenoid valves 2 to the facing surface 20b, and the communication ports 40 extend downward from the valve insertion holes 34 for the spool valves 4 to the facing surface 20b.

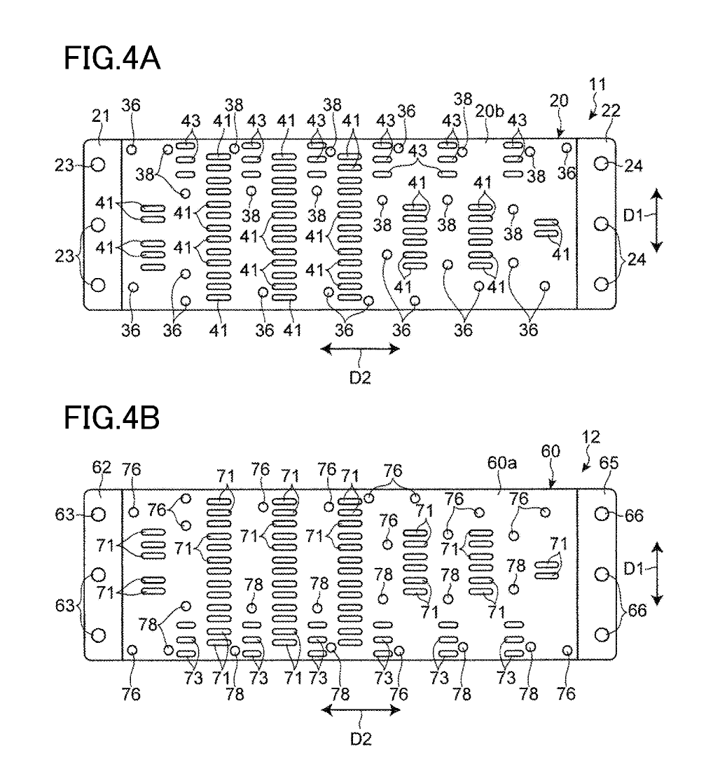

As shown in FIG. 4A, the facing surface 20b is provided with openings 43 of the communication ports 42 communicating with the respective valve insertion holes 33, and openings 41 of the communication ports 40 communicating with the respective valve insertion holes 34. The openings 41 are arranged in the direction D1 at the same locations as the valve insertion holes 34 with respect to the direction D2, so as to correspond to the respective spool valves 4. The openings 43 are arranged in the direction D1 at the same locations as the valve insertion holes 33 with respect to the direction D2, so as to correspond to the respective solenoid valves 2. The shape of each opening 41, 43 is merely an example. However, the opening 41, 43 may have an oblong shape elongated in the direction D2, for example.

The insertion hole arrangement member 11 has, in addition to the bolt holes 36, bolt holes 38 into and through each of which a bolt for use to fix components of the valves 2, 4, a bracket, and other members is inserted and runs. The bolt holes 38 also open through the facing surface 20b. If each communication port 46a, 46b, 47a, 47b, 48, 49, 50 opens also through the facing surface 20b as described above, another opening of the communication port (not shown in FIG. 4A) is also formed through the facing surface 20b.

On the other hand, the oil passage arrangement member 12 is formed by a three-dimensional layer manufacturing process. The material of the oil passage arrangement member 12 should not be specifically limited. However, in this embodiment, the oil passage arrangement member 12 is made of a resin (a synthetic resin). This reduces the weight of the oil passage arrangement member 12.

As shown in FIG. 2, the oil passage arrangement member 12 includes a body portion 60 having a flat block shape and disposed to overlap with the facing surface 20b of the insertion hole arrangement member 11, a pair of positioning portions 61, 64 standing at both ends of the body portion 60 in the direction D2, and a pair of flange portions 62, 65 extending outward in the direction D2 from the upper ends of the respective positioning portions 61, 64. The body portion 60 has an upper surface 60a facing the facing surface 20b of the insertion hole arrangement member 11. The upper surface 60a of the body portion 60 is hereinafter referred to as the facing surface 60a.

The body portion 20 of the insertion hole arrangement member 11 is sandwiched between the pair of positioning portions 61, 64 from both sides thereof in the direction D2 when the insertion hole arrangement member 11 and the oil passage arrangement member 12 are placed one over the other. This allows the oil passage arrangement member 12 to be positioned with respect to the insertion hole arrangement member 11 in the direction D2. The flange portions 62, 65 are respectively disposed under the flange portions 21, 22 of the insertion hole arrangement member 11 to overlap with the flange portions 21, 22. The flange portions 62, 65 respectively have bolt holes 63, 66 each facing the bolt hole 23, 24 of an associated one of the flange portions 21, 22 of the insertion hole arrangement member 11. The insertion hole arrangement member 11 and the oil passage arrangement member 12 are both fixed to the transmission case with the bolts 88 each inserted into an associated adjacent pair of the bolt holes 23, 63 and 24, 66 from below. Thus, the insertion hole arrangement member 11 and the oil passage arrangement member 12 are fastened to each other. Note that the valve body 10 including the insertion hole arrangement member 11 and the oil passage arrangement member 12 which are fastened to each other may be fastened to, and fixed to, the transmission case.

As shown in FIGS. 5-7, the oil passages 69 are provided in the body portion 60 of the oil passage arrangement member 12 to extend basically in a direction parallel to the facing surface 60a. However, the oil passages 69 may extend in a direction inclined relative to the facing surface 60a. Specific features of the oil passages 69, such as the orientations, lengths, layout, and cross-sectional shapes of the oil passages 69, should not be specifically limited.

In the examples shown in FIGS. 6 and 7, the oil passages 69 extend in the direction D2, are parallel to one another, and each have an oblong cross-sectional shape elongated in the direction D1. Each oil passage 69 has a necessary length in the direction D2. Some of the oil passages 69 may be arranged in the direction D2.

In this embodiment, the oil passages 69 are arranged in the direction D1 and in the thickness direction of the oil passage arrangement member 12 (the direction D3). Thus, a plurality of oil passage rows are formed, and each include some of the oil passages 69 aligned in the thickness direction of the oil passage arrangement member 12. Some of the oil passage rows include less ones of the oil passages 69 aligned in the thickness direction of the oil passage arrangement member 12 than the other oil passage rows. Thus, portions of a lower portion of the oil passage arrangement member 12 corresponding to the some of the oil passage rows have no oil passage 69. Portions of the lower surface 60b of the body portion 60 corresponding to the some of the oil passage rows including the less ones of the oil passages 69 each have a recess 68a, 68b. Forming such a recess 68a, 68b as appropriate can reduce the weight of the oil passage arrangement member 12.

The body portion 60 of the oil passage arrangement member 12 has a plurality of connection oil passages 80 connecting the oil passages 69 together. For example, some of the connection oil passages 80 extend in the thickness direction of the oil passage arrangement member 12 to connect together two of the oil passages 69 adjacent to each other in the thickness direction, whereas the other connection oil passages 80 extend in the direction D1 to connect together two of the oil passages 69 adjacent to each other in the direction D1.

The body portion 60 has the communication ports 70, 72. The communication ports 70 extend upward from some of the oil passages 69 (oil passages 69 located near the facing surface 60a and near the valve insertion holes 34) to the facing surface 60a, and each communicate with an associated one of the valve insertion holes 34 through an associated one of the communication ports 40 of the insertion hole arrangement member 11. The communication ports 72 extend upward from different ones of the oil passages 69 (oil passages 69 located near the facing surface 60a and near the valve insertion holes 33) to the facing surface 60a, and each communicate with an associated one of the valve insertion holes 33 through an associated one of the communication ports 42 of the insertion hole arrangement member 11.

As shown in FIG. 4B, the facing surface 60a is provided with openings 71 of the communication ports 70 and openings 73 of the communication ports 72. These openings 71, 73 each have a shape corresponding to that of an associated one of the openings 41, 43 (see FIG. 4A) formed through the facing surface 20b of the insertion hole arrangement member 11, and are connected to the openings 41, 43, respectively. Thus, the some of the oil passages 69 of the oil passage arrangement member 12 and the different ones of the oil passages 69 each communicate with an associated one of the valve insertion holes 34, 33 of the insertion hole arrangement member 11 through an associated pair of the communication ports 40, 70, or 42, 72. The other oil passages 69 each communicate with at least one of the some of the oil passages 69 or the different ones of the oil passages 69 through the associated connection oil passage 80. This shows that the other oil passages 69 also communicate with at least one of the valve insertion holes 33, 34.

If the communication ports 46a, 46b, 47a, 47b, 48, 49, 50 open also through the facing surface 20b as described above, communication ports respectively connected to their openings and each communicating with the specific one of the oil passages 69 open through the facing surface 60a. In FIG. 4B, the openings of the communication ports are not shown.

As shown in FIGS. 6 and 7, oil discharged from a spool valve 4 (or a solenoid valve 2), for example, is first delivered to the some of the oil passages 69 (or the different ones of the oil passages 69), which are allowed to communicate with one of the valve insertion holes 34 (or the valve insertion holes 33) into which the spool valve 4 (or the solenoid valve 2) has been inserted, through the communication ports 40, 70 (or the communication ports 42, 72) communicating with the one of the valve insertion holes 34. Thereafter, the delivered oil is sent through an associated one of the connection oil passages 80 to another one of the oil passages 69 as needed, and is finally guided to a different valve from the valve through which the oil has been discharged, or the communication ports 46a, 46b, 47a, 47b, 48, 49, 50. The oil is introduced into the different valve through some of the communication ports communicating with the valve insertion hole into which the different valve has been inserted and some of the oil passages 69 allowed to communicate with the valve insertion hole through the some of the oil passages 69. The oil is introduced into each of the communication ports 46a, 46b, 47a, 47b, 48, 49, 50 through the specific one of the oil passages 69.

The oil passage arrangement member 12 may further have a communication port communicating with, and connected to, a discharge port of an oil strainer disposed in an oil pan that stores oil. In this case, the communication port opens through the lower surface 60b of the body portion 60, for example.

The body portion 60 of the oil passage arrangement member 12 has bolt holes 76, 78 respectively corresponding to the bolt holes 36, 38 of the insertion hole arrangement member 11. The bolt holes 76, 78 penetrate the oil passage arrangement member 12 in the thickness direction (the direction D3) thereof. These bolt holes 76, 78 open through the facing surface 60a and lower surface 60b of the body portion 60.

The insertion hole arrangement member 11 and the oil passage arrangement member 12 are fixed to the transmission case with the bolts 88 inserted into the pairs of the bolt holes 23, 63, and 24, 66 of the flange portions 21, 62 and 22, 65, and bolts (not shown) inserted into the pairs of the bolt holes 36, 76, such that their facing surfaces 20b, 60a face each other. This allows the insertion hole arrangement member 11 and the oil passage arrangement member 12 to be fastened to each other.

To produce the valve body 10 having the configuration, the insertion hole arrangement member 11 provided with all of the valve insertion holes 33, 34 of the valve body 10, which are arranged in a concentrated manner, is formed with a die (formed by die casting). In addition, the oil passage arrangement member 12 provided with all of the oil passages 69 of the valve body 10, which are arranged in a concentrated manner, is formed (manufactured) with a three-dimensional layer manufacturing machine by a three-dimensional layer manufacturing process.

In the phase of the formation of the insertion hole arrangement member 11, no valve insertion hole 33, 34 is formed. Thus, the formed insertion hole arrangement member 11 is machined (cut) to form the valve insertion holes 33, 34. In the phase of the formation of the insertion hole arrangement member 11, the valve insertion holes 33, 34 may be formed. In this case, the valve insertion holes 33, 34 of the formed insertion hole arrangement member 11 may be finished as needed.

A specific printing method for use in the three-dimensional layer manufacturing process to form the oil passage arrangement member 12 should not be particularly limited. However, if a metal, such as aluminum, is used as a material of the oil passage arrangement member 12, a powder-sintered layer manufacturing process may be used. In this process, the following operation is repeated: portions of a layer comprised of densely packed metal powders which correspond to the portions except the cavities are irradiated with electron beams or laser, for example, so as to be sintered and thus manufactured, and a subsequent layer is then densely packed. Mirror finishing, such as shot peening, is suitably performed to finish the oil passage arrangement member 12 (in this embodiment, made of metal) formed by the three-dimensional layer manufacturing process as described above.

In this embodiment, a resin is used as a material of the oil passage arrangement member 12. Thus, more printing methods can be used than if a metal material is used. If a resin is used as the material of the oil passage arrangement member 12, a powder-sintered layer manufacturing process may also be used. Alternatively, an ink-jet method or any other method may be used. Any printing method satisfying needs merely has to be used.

The formed and machined insertion hole arrangement member 11 and the formed oil passage arrangement member 12 are fastened to, and fixed to, the transmission case while being placed one over the other.

Thereafter, the solenoid valves 2 and the spool valves 4 are each inserted into, and assembled into, an associated one of the valve insertion holes 33, 34 of the insertion hole arrangement member 11. In addition, other necessary components are assembled to the insertion hole arrangement member 11 or the oil passage arrangement member 12.

Note that before the insertion hole arrangement member 11 and the oil passage arrangement member 12 are fastened to, and fixed to, the transmission case, the solenoid valves 2 and the spool valves 4 may be each inserted into an associated one of the valve insertion holes 33, 34, and the necessary components may be attached.

If the insertion hole arrangement member 11 and the oil passage arrangement member 12 are configured to be able to be fastened to each other before being fixed to the transmission case, the insertion hole arrangement member 11 and the oil passage arrangement member 12 are fastened to each other, and then the valve body 10 including the members fastened to each other is fastened to, and fixed to, the transmission case.

The valve body 10 for the hydraulic control system according to the first embodiment provides the following various advantages.

First, the insertion hole arrangement member 11 is formed by die casting that has been generally performed. Thus, a high-quality insertion hole arrangement member 11 with sufficient rigidity can be obtained using a technology that has been nurtured for a long time. In this phase, the valve insertion holes 33, 34 have not been formed yet. Machining (cutting) the insertion hole arrangement member 11 with high rigidity allows the valve insertion holes 33, 34 to be precisely formed. The insertion hole arrangement member 11 with high rigidity is less likely to become deformed even after the machining of the valve insertion holes 33, 34. Thus, the spool 4a can be smoothly moved through the associated valve insertion hole 34 for the spool valve 4. As a result, responsive hydraulic control can be achieved.

The oil passage arrangement member 12 is provided with all of the oil passages 69 of the valve body 10, but the insertion hole arrangement member 11 includes no oil passage 69. This can prevent cut dust produced by machining the valve insertion holes 33, 34 from entering the oil passages 69.

The valve insertion holes 33, 34 each have a diameter that is larger than the width or diameter of each oil passage, and open through one side surface of the body portion 20 in the direction D1. Furthermore, the communication ports 42, 40 each communicating with an associated one of the valve insertion holes 33, 34 open through the facing surface 20b. Thus, cut dust in the valve insertion holes 33, 34 can be easily discharged through the openings of the valve insertion holes 33, 34 on the side surface and the openings 41, 43 of the communication ports 40, 42.

On the other hand, the oil passage arrangement member 12 is formed by a three-dimensional layer manufacturing process. If the oil passage arrangement member 12 is formed by the three-dimensional layer manufacturing process, removal of a die does not have to be taken into account. This can provide a high degree of flexibility in designing specific features of the oil passages 69, such as the shapes and layout of the oil passages 69, without constraints, such as the constraint that the oil passages 69 must each have an opening extending across the length of the oil passage and formed through the facing surface 60a. Thus, layouts that are unachievable in a known valve body formed with a die can be easily achieved. As shown in, for example, FIGS. 6 and 7, three or more of the oil passages 69 may be aligned in the thickness direction (direction D3) of the oil passage arrangement member 12.

The high degree of flexibility in designing the oil passages 69 allows the design of the oil passages 69 to be easily changed. In addition, when the design is to be changed, there is no need for reshaping dies. Thus, the design of the oil passages 69 can be changed in a short period of time at low cost.

Furthermore, if the oil passage arrangement member 12 is formed by the three-dimensional layer manufacturing process, removal of a die and the draft of the die do not have to be taken into account. Thus, the cross-sectional shape of each oil passage 69 of the oil passage arrangement member 12 can be freely designed. Thus, the oil passage arrangement member 12 has to have the communication ports 70, 72 communicating with the valve insertion holes 33, 34 of the insertion hole arrangement member 11, but does not have to further have cavities extending from the respective oil passages 69 to the facing surface 60a.

The communication ports 70, 72 also do not have to have a cross-sectional shape tapered down in a direction away from the facing surface 60a. This can prevent increasing the area of the opening 71, 73 of each communication port 70, 72 on the facing surface 60a from triggering an increase in the size of the entire facing surface 60a, and can prevent reducing the width of a portion of each communication port 70, 72 opposite from the facing surface 60a from triggering an increase in the weight of the oil passage arrangement member 12. This can reduce the size and weight of the oil passage arrangement member 12 and in turn, the valve body 10.

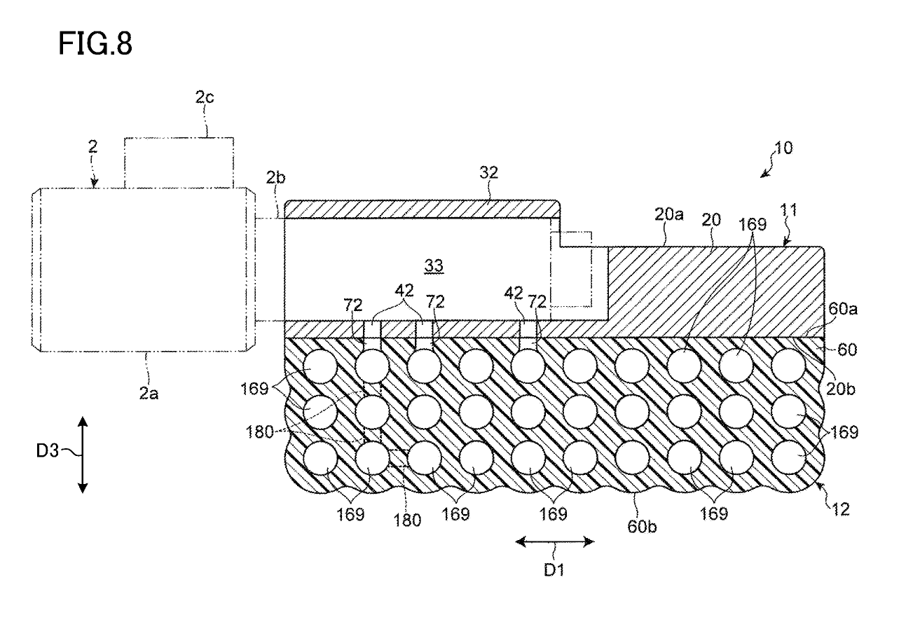

The cross-sectional shape of each oil passage 69 may be freely designed as described above. Thus, the oil passage arrangement member 12 may have oil passages having various cross-sectional shapes instead of the oil passages 69 each having an oblong cross section. For example, oil passages 169 each having a circular cross section shown in FIG. 8 may be provided. Also in the example shown in FIG. 8, the orientation, length, and layout of the oil passages 169, features of connection oil passages 180 connecting the oil passage 169 together, and other features can be freely designed. The shape of the oil passage arrangement member 12 can be designed accordingly as appropriate. This can reduce the size and weight of the oil passage arrangement member 12.

Furthermore, the oil passages 69 do not have to each have an opening extending across its length and formed through the facing surface 60a of the oil passage arrangement member 12. Thus, a separate plate for use to close a large portion of the opening of each of oil passages of a valve body component such as that of a known valve body, can be omitted. The opening extends across the length of the oil passage, and is formed through the facing surface.

The oil passage arrangement member 12 that does not have to have its valve insertion holes 33, 34 machined does not need to have as high rigidity as the rigidity of the insertion hole arrangement member 11. Thus, using a resin as the oil passage arrangement member 12 can further reduce the weight of the oil passage arrangement member 12.

Furthermore, if a resin is used as a material of the member formed by the three-dimensional layer manufacturing process, more printing methods can be used than if a metal material is used thereas. Thus, the oil passage arrangement member 12 with desired quality is easily formed. If the oil passage arrangement member 12 made of a resin is formed by the three-dimensional layer manufacturing process, there is no need for forming support portions for supporting a product portion of the oil passage arrangement member 12 being manufactured from below, depending on the printing method used (for example, in a powder-sintered layer manufacturing process). As a result, there is no need for removing support portions and finishing the remaining portions.

If all or most of the oil passages 69 of the oil passage arrangement member 12 extend parallel to one another, the direction in which layers are stacked to form the oil passage arrangement member 12 by the three-dimensional layer manufacturing process suitably matches the length direction of the oil passages 69. This reduces the degree to which the inner peripheral surfaces of the oil passage 69 become deformed during the manufacture of the oil passage arrangement member 12, thus precisely forming the oil passages 69.

High capability to seal the gap between the facing surfaces 20b, 60a of the insertion hole arrangement member 11 and the oil passage arrangement member 12 is maintained by firmly fastening these members 11, 12 together. Meanwhile, a sheet-like gasket interposed between the facing surfaces 20b, 60a provides high sealability while reducing the number of bolts for use to fasten the members 11, 12 together.

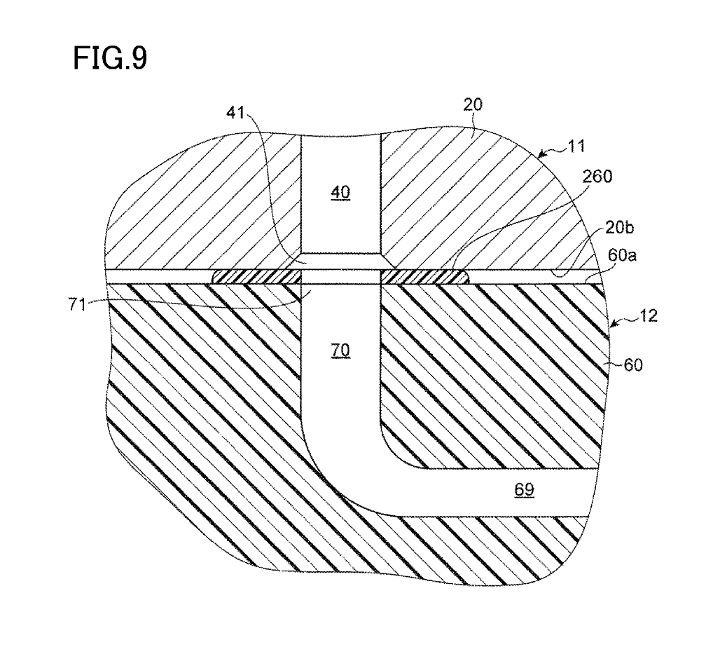

Instead of interposing a gasket between the facing surfaces 20b, 60a, a sealing member 260, 364, 462, 522 sealing the junction between each facing pair of the communication ports 40, 70 (the communication ports 42, 72) may be provided around the opening of at least one of the communication ports 40, 70 (the communication ports 42, 72) of the insertion hole arrangement member 11 and the oil passage arrangement member 12 connected to each other (around the opening 41 and/or the opening 71, or around the opening 43 and/or the opening 73), as in the examples shown in, for example, FIGS. 9-12. This also provides high sealability while reducing the number of bolts for use to fasten the members 11, 12 together.

FIGS. 9-12 each show how an associated one of the sealing members 260, 364, 462, 522 seals the junction between facing ones of the communication ports 40, 70 through which the valve insertion hole 34 for the spool valve 4 communicates with an associated one of the oil passages 69. However, how to seal the junction between facing ones of the communication ports 42, 72 through which the valve insertion hole 33 for the solenoid valve 2 communicates with an associated one of the oil passages 69 is also similar to how to seal the junction between the facing ones of the communication ports 40, 70. How to seal the junction between the facing ones of the communication ports 40, 70 will be described below in detail.

In the example shown in FIG. 9, the annular sealing member 260 is provided around the opening 71 on the facing surface 60a of the oil passage arrangement member 12 (at the periphery of the opening 71 in the example shown in FIG. 9). The sealing member 260 is connected to the body portion 60 made of a synthetic resin. The sealing member 260 is made of a synthetic resin that is softer than the body portion 60. The oil passage arrangement member 12 formed by the three-dimensional layer manufacturing process allows the body portion 60 and the sealing member 260 which are made of different materials as in the example shown in FIG. 9 to be connected together.

According to the example shown in FIG. 9, fastening the insertion hole arrangement member 11 and the oil passage arrangement member 12 together allows the sealing member 260 to be sandwiched between the facing surfaces 20b, 60a of the members 11, 12 at the periphery of the opening 41, 71 of the communication port 40, 70. As a result, the sealing member 260 is compressed and deformed in the thickness direction of the sealing member 260. This allows the junction between the facing ones of the communication ports 40, 70 at the facing surfaces 20b, 60a (the peripheries of the openings 41, 71) to be satisfactorily sealed.

As a result, even if the entire facing surfaces 20b, 60a are not brought into tight contact with each other by being fastened together using many bolts, only four corners of the facing surfaces 20b, 60a, for example, may be fastened together with bolts to provide high sealability. This can reduce the number of bolts for use to fasten the insertion hole arrangement member 11 and the oil passage arrangement member 12 together, and thus reduce the space required to form bolt holes and their surrounding bosses, thereby further reducing the size and weight of the valve body 10. No gasket is also required, and the sealing member 260 is connected to the body portion 60 of the oil passage arrangement member 12. This provides high sealability while reducing the number of components and the number of assembly process steps.

Furthermore, individually sealing the junctions between the facing ones of the communication ports 40, 70 formed through the facing surfaces 20b, 60a effectively prevents oil from leaking into the gap between the facing surfaces 20b, 60a. This can prevent oil from flowing from an oil passage through the gap between the facing surfaces 20b, 60a into another oil passage without providing an oil passage only for a drain, unlike a known valve body. Thus, eliminating such an oil passage only for a drain can further reduce the size of the oil passage arrangement member 12.

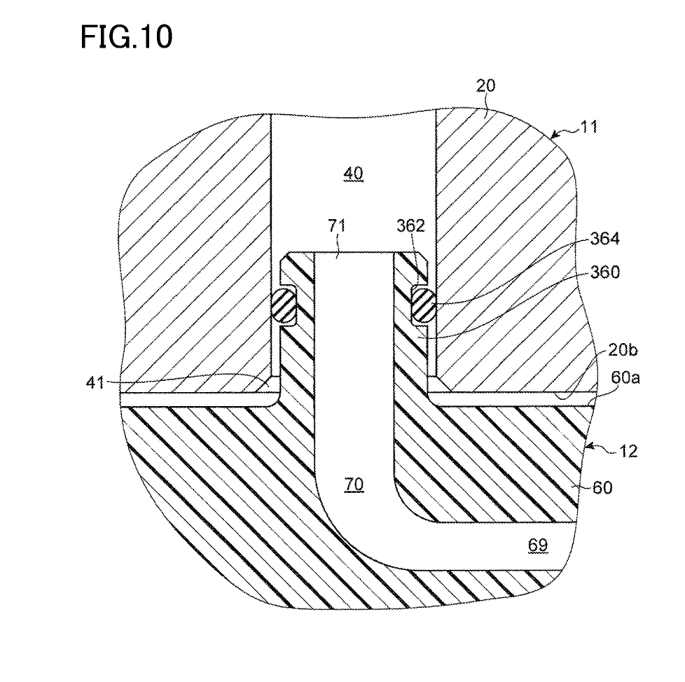

FIGS. 10-12 each show a variation of a component for sealing a junction between facing ones of the communication ports 40, 70 (a sealing member).

In a first variation shown in FIG. 10, the oil passage arrangement member 12 has tubular protruding portions 360, which are portions of the facing surface 60a surrounding the communication ports 70 and protruding toward the insertion hole arrangement member 11. The protruding portions 360 are each provided, at its tip end, with the opening 71 of the communication port 70. The protruding portions 360 are fitted into the communication ports 40 of the insertion hole arrangement member 11, respectively. The outer peripheral surface of each protruding portion 360 (a portion of the oil passage arrangement member 12 surrounding the opening 71 of each communication port 70) has an annular groove 362, into which an O ring 364 made of rubber, for example, and serving as a sealing member is fitted.

According to the first variation shown in FIG. 10, the O ring 364 sandwiched between the bottom of the groove 362 and the inner peripheral surface of the associated communication port 40 so as to be radially compressed and deformed satisfactorily seals the junction between the communication ports 40 and 70 (a region where the protruding portion 360 and the communication port 40 are fitted to each other), just like the example shown in FIG. 9.

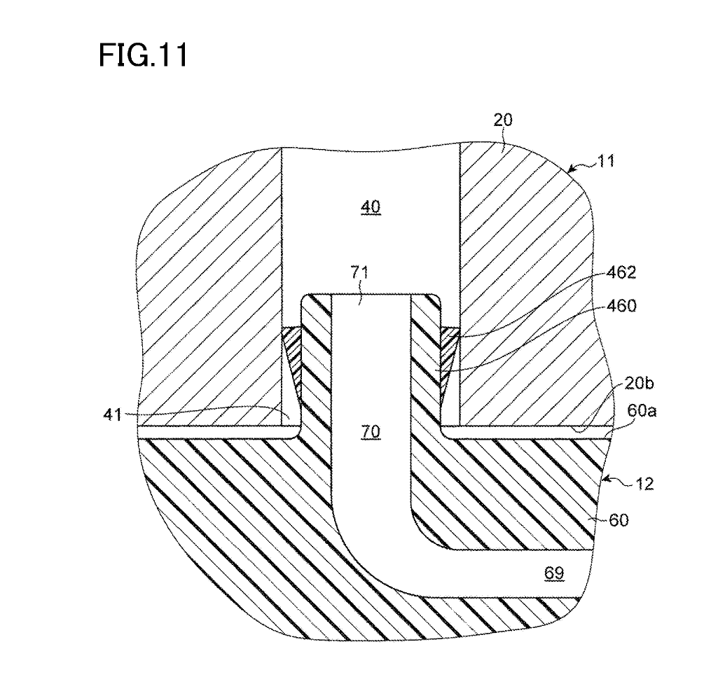

In a second variation shown in FIG. 11, the oil passage arrangement member 12 has tubular protruding portions 460 similar to the protruding portions 360 of the first variation. The protruding portions 460 are each provided, at its tip end, with the opening 71 of the communication port 70. The protruding portions 460 are fitted into the communication ports 40 of the insertion hole arrangement member 11, respectively. An annular sealing member 462 is provided on the outer peripheral surface of each protruding portion 460 (a portion of the oil passage arrangement member 12 surrounding the opening 71 of the associated communication port 70), so as to be connected to the protruding portion 460. While the protruding portion 460 is made of the same synthetic resin as the body portion 60, and connected to the body portion 60, the sealing member 462 is made of a synthetic resin that is softer than the body portion 60 and the protruding portion 460. The oil passage arrangement member 12 formed by the three-dimensional layer manufacturing process allows each protruding portion 460 and the associated sealing member 462 which are made of different materials as described above to be connected together.

According to the second variation shown in FIG. 11, the sealing member 462 sandwiched between the outer peripheral surface of the protruding portion 460 and the inner peripheral surface of the associated communication port 40 so as to be radially compressed and deformed satisfactorily seals the junction between the communication ports 40 and 70 (a region where the protruding portion 460 and the communication port 40 are fitted to each other), just like the examples shown in FIGS. 9 and 10. The sealing member 462 is connected to the body portion 60 and associated protruding portion 460 of the oil passage arrangement member 12. This can reduce the number of components and the number of assembly process steps, just like the example shown in FIG. 9.

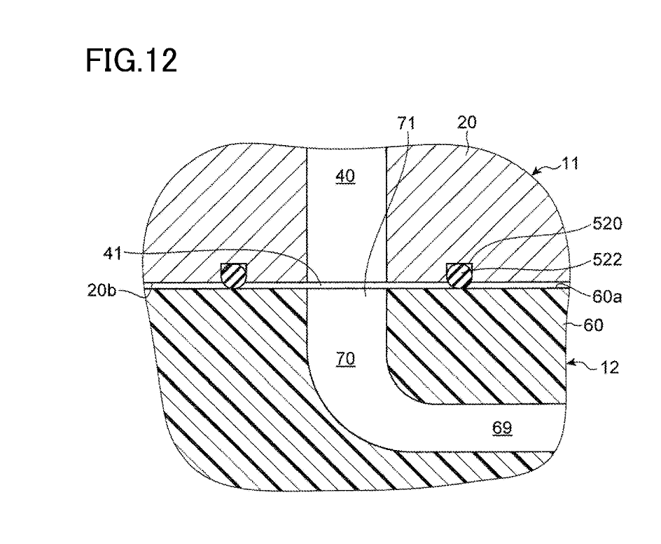

In a third variation shown in FIG. 12, portions of the facing surface 20b of the insertion hole arrangement member 11 surrounding the openings 41 each have an annular groove 520 to surround an associated one of the openings 41. An O ring 522 made of, for example, rubber and serving as a sealing member is fitted into the groove 520.

According to the third variation shown in FIG. 12, fastening the insertion hole arrangement member 11 and the oil passage arrangement member 12 together allows the O ring 522 to be sandwiched between the facing surfaces 20b, 60a of the members 11 and 12 and disposed around associated facing ones of the openings 41, 71 of the communication ports 40, 70. As a result, the O ring 522 is compressed and deformed in the thickness direction of the O ring 522. This allows the junction between the associated facing ones of the communication ports 40, 70 formed through the facing surfaces 20b, 60a (portions surrounding the openings 41, 71) to be satisfactorily sealed, just like the examples shown in FIGS. 9-11.

### Second Embodiment

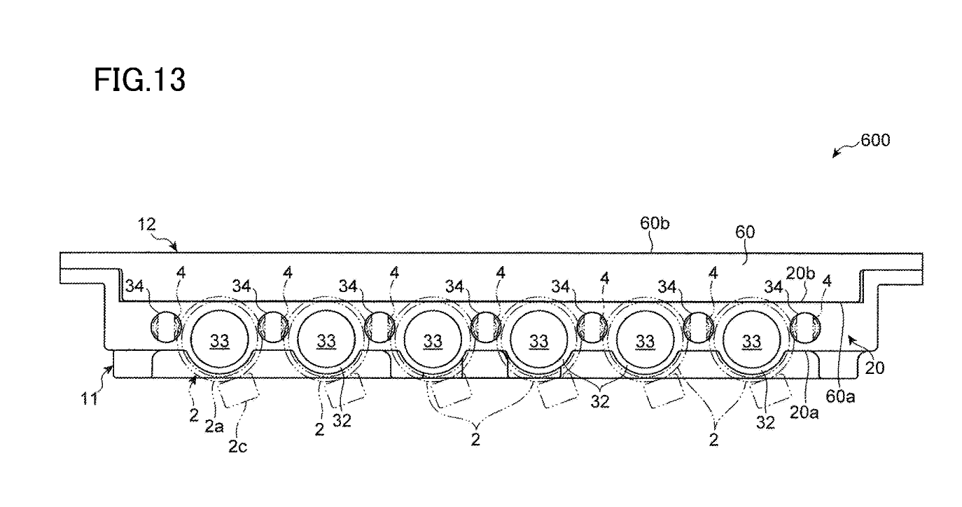

FIG. 13 illustrates a valve body 600 for a hydraulic control system according to a second embodiment of the present invention. In the second embodiment, like reference characters are used in FIG. 13 to designate elements similar to those of the first embodiment, and explanation thereof is omitted.

In this embodiment, the valve body 600 includes an insertion hole arrangement member 11 and an oil passage arrangement member 12. The insertion hole arrangement member 11 is provided with all of valve insertion holes 33, 34 of the valve body 600, which are arranged in a concentrated manner. The oil passage arrangement member 12 is provided with all of oil passages 69 of the valve body 600, which are arranged in a concentrated manner. While the valve body 600 is attached to an automatic transmission, the insertion hole arrangement member 11 is placed under, and fastened to, the oil passage arrangement member 12. The structures of the insertion hole arrangement member 11 and the oil passage arrangement member 12 are generally arranged upside down relative to those of the first embodiment. How the valve insertion holes 33, 34 of the insertion hole arrangement member 11 are each connected to an associated one of the oil passages 69 of the oil passage arrangement member 12 is similar to that of the first embodiment, except that the valve insertion hole 33, 34 and the associated oil passage 69 are inverted. Other features of the valve body 600 and a method for producing the valve body 600 are similar to those of the first embodiment.

In this embodiment, the lower surface of the insertion hole arrangement member 11 has communication ports (corresponding to the communication ports 46a, 46b, 47a, 47b, 48, 49, 50 of the first embodiment (see FIG. 3)) communicating with a plurality of oil passages inside the wall of a transmission case, respectively. The lower surface of the insertion hole arrangement member 11 is fixed to the upper surface of the transmission case, so that the valve body 600 is attached to the transmission case.

Note that the communication ports may be opened through the upper surface of the oil passage arrangement member 12 to fix the upper surface of the oil passage arrangement member 12 to the lower surface of the transmission case.

The valve body 600 according to the second embodiment configured as described above can also provide operational advantages similar to those of the first embodiment.

For example, the insertion hole arrangement member 11 having no oil passage 69 can prevent cut dust produced by machining the insertion hole arrangement member 11, formed by die casting, to form the valve insertion holes 33, 34 from entering the oil passages 69. The cut dust in the valve insertion holes 33, 34 can be easily discharged through the openings of the valve insertion holes 33, 34 and other sections. Furthermore, since the insertion hole arrangement member 11 with high rigidity is machined (cut), the valve insertion holes 33, 34 can be precisely formed. The shape, layout, and other features of the oil passages 69 of the oil passage arrangement member 12 formed by a three-dimensional layer manufacturing process can be freely designed. This can effectively reduce the size and weight of the oil passage arrangement member 12 as compared to a valve body component of a known valve body.

Also in this embodiment, such a sealing structure as shown in FIGS. 9-12, for example, is used for the facing surfaces 20b, 60a of the insertion hole arrangement member 11 and the oil passage arrangement member 12, thus eliminating a gasket and providing high sealability. In particular, if a sealing member 260, 462 connected to the oil passage arrangement member 12 is formed by the three-dimensional layer manufacturing process as in the example shown in FIG. 9 or 11, the number of components can be reduced, and high sealability can be provided.

### Third Embodiment

FIG. 14 illustrates a valve body 610 for a hydraulic control system according to a third embodiment of the present invention. In the third embodiment, like reference characters are used in FIG. 14 to designate elements similar to those of the first embodiment, and explanation thereof is omitted.

The valve body 610 includes two insertion hole arrangement members 611, 612 vertically arranged one over the other. The upper insertion hole arrangement member 611 is provided with all of valve insertion holes 33 (for solenoid valves 2) of the valve body 610, which are arranged in a concentrated manner. The lower insertion hole arrangement member 612 is provided with all of valve insertion holes 34 (for spool valves 4) of the valve body 610, which are arranged in a concentrated manner. These insertion hole arrangement members 611, 612 are both members formed by die casting and made of aluminum. The formed insertion hole arrangement member 611 is machined (cut) to form valve insertion holes 33. The formed insertion hole arrangement member 612 is machined (cut) to form valve insertion holes 34.

The valve body 610 further includes an oil passage arrangement member 613 provided with all of oil passages 69 of the valve body 610, which are arranged in a concentrated manner. The oil passage arrangement member 613 is a member formed by the three-dimensional layer manufacturing process and made of a resin (a synthetic resin), just like the first embodiment.

The insertion hole arrangement members 611 and 612 and the oil passage arrangement member 613 are fastened together while being placed one over another so as to be aligned in this order from above. Thus, the valve body 610 has a three-layer structure.

In this valve body 610, the valve insertion holes 34 of the insertion hole arrangement member 612 communicate with some of the oil passages 69 through the respective communication ports 40, just like the first embodiment.

Meanwhile, the valve insertion holes 33 of the insertion hole arrangement member 611 communicate with different ones of the oil passages 69 through the respective communication ports 42 extending continuously through the insertion hole arrangement members 611 and 612. The communication ports 42 extend through a portion of the insertion hole arrangement member 611 from the valve insertion holes 33 to the lower surface of the insertion hole arrangement member 611, and penetrate the insertion hole arrangement member 612 in the thickness direction thereof.

In this embodiment, the oil passage arrangement member 613 has an orifice member insertion port 13 into which an orifice member 14 separate from the insertion hole arrangement members 611, 612 and the oil passage arrangement member 613 is inserted, and a check valve insertion port 16 into which a check valve 17 separate from the insertion hole arrangement members 611, 612 and the oil passage arrangement member 613 is inserted.

The orifice member 14 inserted into the orifice member insertion port 13 enters a predetermined one of the oil passages 69 to define an orifice in the oil passage 69. The check valve 17 inserted into the check valve insertion port 16 prevents oil from flowing through another predetermined one of the oil passages 69 in a reverse direction. The another predetermined one of the oil passages 69 may be identical to the predetermined one of the oil passages 69. Instead of, or in addition to, the oil passage arrangement member 613, the insertion hole arrangement member 611 and/or the insertion hole arrangement member 612 may also have an orifice member insertion port 13 (an orifice member 14) to define an orifice in an associated one of the communication ports 42. Instead of, or in addition to, the oil passage arrangement member 613, the insertion hole arrangement member 611 and/or the insertion hole arrangement member 612 may also have a check valve insertion port 16 (a check valve 17).

The valve body 610 having the three-layer structure described above can also provide operational advantages similar to those of the first embodiment.

In the third embodiment, the insertion hole arrangement member 611 is provided with all of the valve insertion holes 33 of the valve body 610, which are arranged in a concentrated manner, and the insertion hole arrangement member 612 is provided with all of the valve insertion holes 34 of the valve body 610, which are arranged in a concentrated manner. However, the insertion hole arrangement member 611 may be provided with most of all the valve insertion holes 33 of the valve body 610, which are arranged in a concentrated manner, and the insertion hole arrangement member 612 may be provided with a few ones of the valve insertion holes 33, which are arranged together with all of the valve insertion holes 34 of the valve body 610.

Alternatively, the insertion hole arrangement member 612 may be provided with most of all the valve insertion holes 33 of the valve body 610, which are arranged in a concentrated manner, and the insertion hole arrangement member 611 may be provided with a few ones of the valve insertion holes 34, which are arranged together with all of the valve insertion holes 33 of the valve body 610.

Still alternatively, the insertion hole arrangement members 611 and 612 do not have to have the valve insertion holes 33, 34, respectively, which are arranged in a concentrated manner. For example, the insertion hole arrangement members 611 and 612 may each have the valve insertion holes 33, 34 alternately arranged, just like the insertion hole arrangement member 11 according to the first embodiment.

### Fourth Embodiment

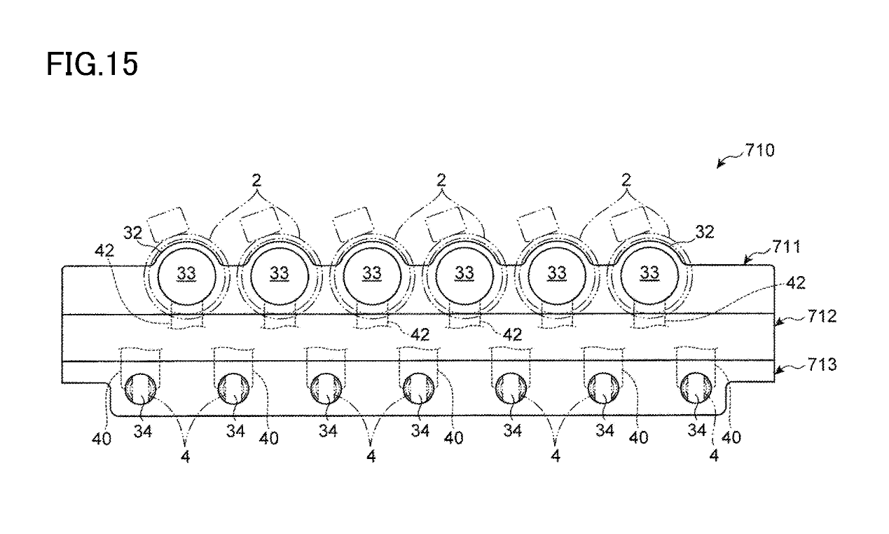

FIG. 15 illustrates a valve body 710 for a hydraulic control system according to a fourth embodiment of the present invention. In the fourth embodiment, like reference characters are used in FIG. 15 to designate elements similar to those of the first embodiment, and explanation thereof is omitted.

The valve body 710 is similar to that of the third embodiment, because it includes two insertion hole arrangement members 711 and 713 and one oil passage arrangement member 712, and has a three-layer structure. However, how to arrange the two insertion hole arrangement members 711 and 713 and the oil passage arrangement member 712 of the valve body 710 is different from that in the third embodiment.

Specifically, in this embodiment, the insertion hole arrangement member 711, the oil passage arrangement member 712, and the insertion hole arrangement member 713 are fastened together while being placed one over another so as to be aligned in this order from above. The insertion hole arrangement member 711 is provided with all of the valve insertion holes 33 of the valve body 710, which are arranged in a concentrated manner. The oil passage arrangement member 712 is provided with all of the oil passages 69 of the valve body 710, which are arranged in a concentrated manner. The insertion hole arrangement member 713 is provided with all of the valve insertion holes 34 of the valve body 710, which are arranged in a concentrated manner.

As in the third embodiment, these insertion hole arrangement members 711 and 713 are both members formed by die casting and made of aluminum. The formed insertion hole arrangement member 711 is machined (cut) to form valve insertion holes 33. The formed insertion hole arrangement member 713 is machined (cut) to form valve insertion holes 34. The oil passage arrangement member 712 is a member formed by the three-dimensional layer manufacturing process and made of a resin (a synthetic resin), just like the third embodiment.

In the valve body 710, the upper surface of the oil passage arrangement member 712 serves as a facing surface that faces the insertion hole arrangement member 711, and the lower surface of the oil passage arrangement member 712 serves as a facing surface that faces the insertion hole arrangement member 713. The lower surface of the insertion hole arrangement member 711 serves as a facing surface that faces the oil passage arrangement member 712, and the upper surface of the insertion hole arrangement member 713 serves as a facing surface that faces the oil passage arrangement member 712.

In this valve body 710, the valve insertion holes 34 of the insertion hole arrangement member 713 communicate with some of the oil passages 69 through the respective communication ports 40, just like the first embodiment. The valve insertion holes 33 of the insertion hole arrangement member 711 communicate with different ones of the oil passages 69 through the respective communication ports 42, just like the first embodiment. The communication ports 40 open through the facing surfaces of the insertion hole arrangement member 713 and the oil passage arrangement member 712. The communication ports 42 open through the facing surfaces of the insertion hole arrangement member 711 and the oil passage arrangement member 712.

The valve body 710 configured as described above can also provide operational advantages similar to those of the first embodiment. Separately providing one of the insertion hole arrangement members 711 and 713 over the oil passage arrangement member 712 and the other one under the oil passage arrangement member 712 allows the communication ports 40, 42, through which the valve insertion holes 33, 34 are allowed to communicate with the associated oil passages 69, to be respectively formed through the upper and lower surfaces of the oil passage arrangement member 712. This increases the degree of flexibility in designing a layout of these communication ports 40, 42.

In the fourth embodiment, just like the third embodiment, the insertion hole arrangement member 711 is provided with all of the valve insertion holes 33 of the valve body 710, which are arranged in a concentrated manner, and the insertion hole arrangement member 713 is provided with all of the valve insertion holes 34 of the valve body 710, which are arranged in a concentrated manner. However, such arrangement is merely an example. Modifications described in the third embodiment may be made.

The present invention is not limited to the above embodiments, and capable of substitutions without departing from the scope of the claims.

An example in which the insertion hole arrangement member is an aluminum member formed with a die has been described in the embodiments. However, the insertion hole arrangement member may be made of a metal except aluminum or a material except the metal (e.g., a resin). The insertion hole arrangement member does not always have to be formed with a die, but may be formed by a three-dimensional layer manufacturing process, for example.

An example in which the oil passage arrangement member is made of a resin has been described in the embodiments. However, the oil passage arrangement member may be made of a material except a resin (e.g., a metal such as aluminum).

An example in which the insertion hole arrangement member is provided with all of the valve insertion holes of the valve body arranged in a concentrated manner, and the oil passage arrangement member is provided with all of the oil passages of the valve body arranged in a concentrated manner has been described in the embodiments. However, the insertion hole arrangement member may be provided with most of all the valve insertion holes of the valve body arranged in a concentrated manner, and the oil passage arrangement member may be provided with a few remaining valve insertion holes arranged together with all or most of the oil passages of the valve body. If valve insertion holes are arranged in the oil passage arrangement member as described above, the valve insertion holes may also be formed by a three-dimensional layer manufacturing process. This eliminates the need for cutting the valve insertion holes. However, valve insertion holes formed by the three-dimensional layer manufacturing process may be finished as needed.

The oil passage arrangement member may be provided with most of all the oil passages of the valve body, which are arranged in a concentrated manner, and the insertion hole arrangement member may be provided with a few remaining ones of the oil passages, which are arranged together with all or most of the valve insertion holes of the valve body. Even if the insertion hole arrangement member is provided with some of the oil passages as described above, the number of the some oil passages is small. Thus, a surface of the insertion hole arrangement member facing the oil passage arrangement member may have oil passages, and the insertion hole arrangement member may be formed with a die. If oil passages are provided inside the insertion hole arrangement member, the insertion hole arrangement member is suitably formed by the three-dimensional layer manufacturing process.

Furthermore, an example in which the valve body includes one or two insertion hole arrangement members and one oil passage arrangement member has been described in the embodiments. However, three or more insertion hole arrangement members may be provided, or two or more oil passage arrangement members may be provided. If a plurality of insertion hole arrangement members and/or a plurality of oil passage arrangement members are provided, the insertion hole arrangement members and the oil passage arrangement members are suitably alternately placed one over another, just like the fourth embodiment. The insertion hole arrangement members and the oil passage arrangement members alternately placed one over another increases the degree of flexibility in designing how the valve insertion holes of each insertion hole arrangement member are allowed to communicate with the associated oil passages of the associated oil passage arrangement members.

An example in which the present invention is applied to a valve body for a hydraulic control system for use to control the hydraulic pressure of the automatic transmission has been described in the embodiments. However, the present invention may be applied to any hydraulic control system valve body, and is suitable for, in particular, a valve body including many valves.

The foregoing embodiments are merely examples, and the scope of the present invention should not be construed to be limiting. The scope of the present invention should be defined by the appended claims, and all the modifications and changes which fall within the scope of equivalents of the appended claims are within the scope of the present invention.

### INDUSTRIAL APPLICABILITY

The present invention is useful for a valve body for a hydraulic control system and a method for producing the same, and is particularly useful for a valve body including many valves, such as a valve body for a hydraulic control system for use to control the hydraulic pressure of an automatic transmission of a vehicle, and a method for producing the valve body.

### DESCRIPTION OF REFERENCE CHARACTERS

2 Solenoid Valve
4 Spool Valve
10 Valve Body
11 Insertion Hole Arrangement Member
12 Oil Passage Arrangement Member
13 Orifice Member Insertion Port
14 Orifice Member
16 Check Valve Insertion Port
17 Check Valve
33 Valve Insertion Hole For Solenoid Valve
34 Valve Insertion Hole For Spool Valve
69 Oil Passage
260 Sealing Member
364 O Ring (Sealing Member)
462 Sealing Member
522 O Ring (Sealing Member)
600 Valve Body
611 Insertion Hole Arrangement Member
612 Insertion Hole Arrangement Member
613 Oil Passage Arrangement Member
710 Valve Body
711 Insertion Hole Arrangement Member
712 Oil Passage Arrangement Member
713 Insertion Hole Arrangement Member

1. A valve body for a hydraulic control system, the valve body having a plurality of valve insertion holes into which a plurality of valves are inserted, respectively, and a plurality of oil passages each communicating with at least one of the valve insertion holes, the valve body comprising:
an insertion hole arrangement member provided with the valve insertion holes of the valve body, which are arranged in a concentrated manner; and
an oil passage arrangement member placed on the insertion hole arrangement member, and provided with the oil passages of the valve body, which are arranged in a concentrated manner.

2. The valve body of claim 1, wherein
the oil passage arrangement member is formed by a three-dimensional layer manufacturing process.

3. The valve body of claim 1, wherein
the insertion hole arrangement member is formed by die casting.

4. The valve body of claim 1, wherein
the oil passage arrangement member is made of a resin.

5. The valve body of claim 1, wherein
the insertion hole arrangement member includes a plurality of insertion hole arrangement members, and/or the oil passage arrangement member includes a plurality of oil passage arrangement members, and
the insertion hole arrangement members and the oil passage arrangement members are alternately placed one over another.

6. The valve body of claim 1, wherein
a plurality of first communication ports each communicating with at least one of the valve insertion holes open through a surface of the insertion hole arrangement member facing the oil passage arrangement member,
a plurality of second communication ports each connected to an associated one of the first communication ports of the insertion hole arrangement member open through a surface of the oil passage arrangement member facing the insertion hole arrangement member, and a sealing member is provided around an opening of at least one of the first communication port or the second communication port to seal a junction between the first and second communication ports.

7. The valve body of claim 6, wherein
the sealing member is provided around the opening of each of the second communication ports of the oil passage arrangement member,
the oil passage arrangement member includes a body portion made of a synthetic resin and integrated with the sealing member, and
the sealing member is made of a synthetic resin that is softer than the body portion.

8. The valve body of claim 1, wherein
the insertion hole arrangement member and/or the oil passage arrangement member have/has an orifice member insertion port into which an orifice member separate from the insertion hole arrangement member and the oil passage arrangement member is inserted.

9. The valve body of claim 1, wherein
the insertion hole arrangement member and/or the oil passage arrangement member have/has a check valve insertion port into which a check valve separate from the insertion hole arrangement member and the oil passage arrangement member is inserted.

10. A method for producing a valve body for a hydraulic control system, the valve body having a plurality of valve insertion holes into which a plurality of valves are inserted, respectively, and a plurality of oil passages each communicating with at least one of the valve insertion holes, the method comprising:
forming, with a die, an insertion hole arrangement member, the insertion hole arrangement member being provided with valve insertion holes of the valve body, which are arranged in a concentrated manner;
forming, by a three-dimensional layer manufacturing process, an oil passage arrangement member provided with the oil passages of the valve body, which are arranged in a concentrated manner; and
after the forming of the insertion hole arrangement member and after the forming of the oil passage arrangement member, fastening the insertion hole arrangement member and the oil passage arrangement member together with the insertion hole arrangement member and the oil passage arrangement member placed one over the other.
